(19) United States
(12) Patent Application Publication
(10) Pub. No.: US 2018/0275779 A1
(43) Pub. Date: Sep. 27, 2018

(54) ELECTRONIC WRITING APPARATUS

(71) Applicants: WEN-BIN CHEN, Taipei City (TW); BANDRICH, INC., Taipei City (TW)

(72) Inventors: WEN-BIN CHEN, Taipei City (TW); HAN-PO TSAI, Taipei City (TW)

(21) Appl. No.: 15/659,262

(22) Filed: Jul. 25, 2017

(30) Foreign Application Priority Data
Mar. 24, 2017 (TW) 106204190

(51) Int. Cl. G06F 3/0354; G06F 3/041; G06F 3/046

(52) U.S. Cl. CPC G06F 3/03545; G06F 3/04883; G06F 3/046; G06F 3/0414

(57) ABSTRACT

An electronic writing apparatus is provided. The electronic writing apparatus includes a cholesteric liquid crystal writing tablet, a trace recording unit, a processing module and a transmission interface. The cholesteric liquid crystal writing tablet has a writing/display surface for receiving a writing pressure to display writing trace according to a motion path of the writing pressure. The trace recording unit is disposed on a side of the cholesteric liquid crystal writing tablet opposite to the writing/display surface for detecting a position coordinate of the writing pressure. The processing module is electrically connected to the trace recording unit, and the processing module receives and converts the position coordinate to a writing data corresponding to the writing trace. The transmission interface is electrically connected to the processing module, and the writing data is transmitted to and stored in a cloud computing system or an external electronic apparatus through the transmission interface.

### BACKGROUND OF THE INVENTION

### 1. Field of the Invention

The instant disclosure relates to an electronic writing apparatus; in particular, to an electronic writing apparatus capable of transmitting writing data to another electronic device.

### 2. Description of Related Art

The existing writing materials, such as pens and papers, have been widely used due to its cheap price. However, the paper with handwriting may not be reused. Furthermore, if each of the papers recording important information has to be preserved for long periods, a large space will be occupied.

Electronic writing tablets, such as a cholesteric liquid crystal display writing tablet, have been developed. The user presses the cholesteric liquid crystal display writing tablet with an object (finger or stylus) to draw or write on the cholesteric liquid crystal display writing tablet. The cholesteric liquid crystal display writing tablet can display and maintain the drawing or the handwriting without the power supply in the process of drawing or writing. After drawing or writing, the user presses a button to input a command for controlling a voltage driving unit of the electronic writing tablet to output a voltage, so that the image displayed on the screen of the electronic writing tablet can be erased. Accordingly, this type of the electronic writing tablet can be reused many times. However, the writing or drawing images cannot be stored, which is not convenient to the user.

### SUMMARY OF THE INVENTION

The object of the instant disclosure is to provide an electronic writing apparatus, which allows user to write many times. In addition, the contents written on the electronic apparatus can be stored.

In order to achieve the aforementioned objects, according to an embodiment of the instant disclosure, an electronic writing apparatus is provided. The electronic writing apparatus includes a cholesteric liquid crystal writing tablet, a trace recording unit, a processing module, and a transmission interface electrically connected to the processing module. The cholesteric liquid crystal writing tablet has a writing/display surface for receiving a writing pressure to display a writing trace according to a motion path of the writing pressure. The trace recording unit is disposed on a side of the cholesteric liquid crystal writing tablet opposite to the writing/display surface for detecting a position coordinate of the writing pressure. The processing module is electrically connected to the trace recording unit for receiving and converting the position coordinate of the writing pressure to a writing data corresponding to the writing trace. The processing module transmits the writing data to a cloud computing system or an external electronic apparatus through the transmission interface for storage.

The electronic writing apparatus of the instant disclosure can store the writing data generated when the user finishes writing or drawing by the operations of the trace recording unit, the processing module, and the transmission interface. The trace recording unit can detect the position coordinate where the writing pressure is applied and transmit the position coordinate to the processing module. The processing module converts the position coordinate to the writing data, and the writing data is transmitted to and stored in the cloud computing system or the external electronic apparatus through the transmission interface.

In order to further the understanding regarding the instant disclosure, the following embodiments are provided along with illustrations to facilitate the disclosure of the instant disclosure.

### BRIEF DESCRIPTION OF THE DRAWINGS

FIG. 1 shows a functional diagram of an electronic writing apparatus according to an embodiment of the instant disclosure;

FIG. 2 shows a localized cross-sectional view of a cholesteric liquid crystal writing tablet and a trace recording unit according to an embodiment of the instant disclosure;

FIG. 3 shows a perspective diagram of an electronic writing tablet which is in use according to an embodiment of the instant disclosure; and

FIG. 4 shows a functional diagram of a signature authentication system including an electronic writing apparatus according to an embodiment of the instant disclosure.

### DETAILED DESCRIPTION OF THE PREFERRED EMBODIMENTS

The aforementioned illustrations and following detailed descriptions are exemplary for the purpose of further explaining the scope of the instant disclosure. Other objectives and advantages related to the instant disclosure will be illustrated in the subsequent descriptions and appended drawings.

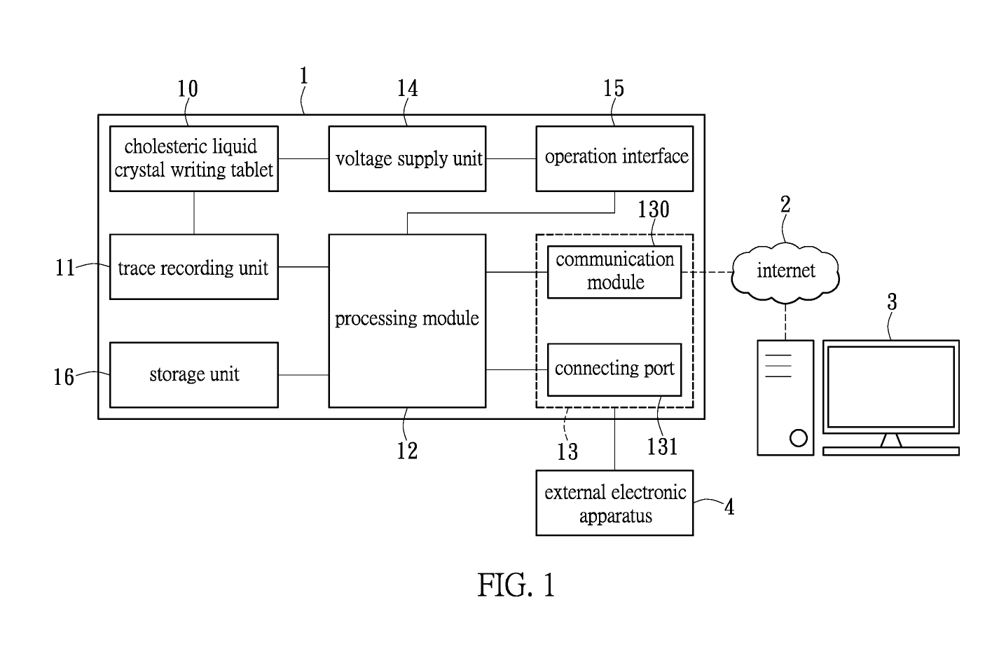

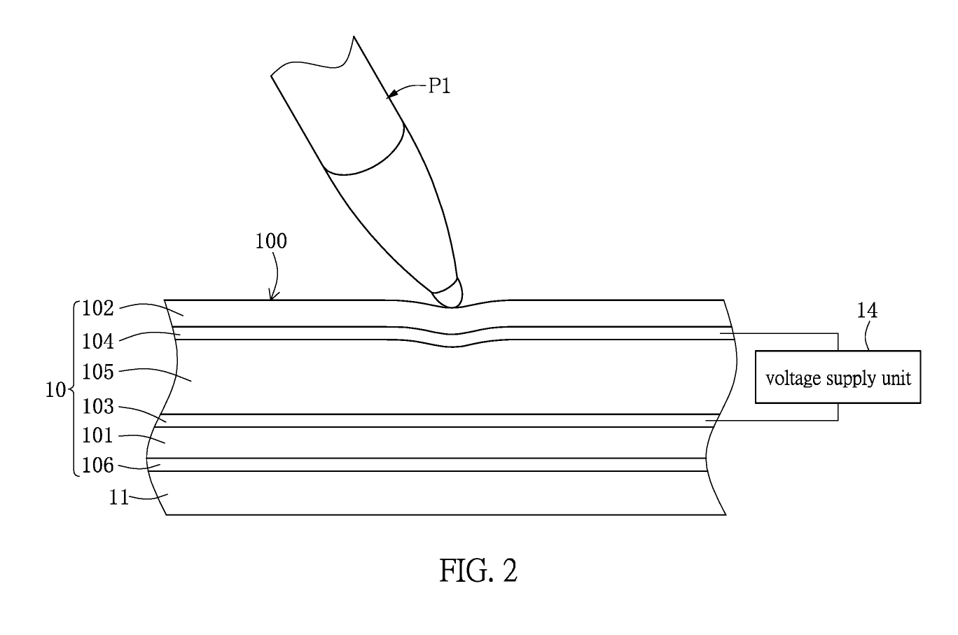

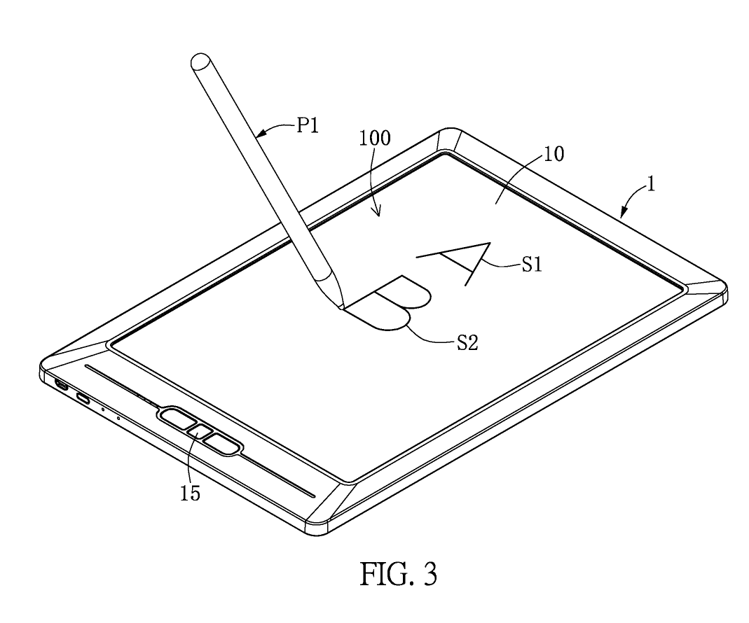

Please refer to FIG. 1 to FIG. 3. FIG. 1 shows a functional diagram of an electronic writing apparatus according to an embodiment of the instant disclosure, FIG. 2 shows a localized cross-sectional view of a cholesteric liquid crystal writing tablet and a trace recording unit according to an embodiment of the instant disclosure, and FIG. 3 shows a perspective diagram of an electronic writing tablet which is in use according to an embodiment of the instant disclosure.

As shown in FIG. 1, an electronic writing apparatus 1 includes a cholesteric liquid crystal writing tablet 10, a trace recording unit 11, a processing module 12, and a transmission interface 13. In general, when a user is writing or painting using the cholesteric liquid crystal writing tablet 10, the trace recording unit 11 detects a writing trace generated by the user and then transmits it to the processing module 12. Subsequently, the writing data generated by the processing module 12 according to the writing trace is transmitted to and then stored in a cloud computing system 13 or an external electronic apparatus 4 through the transmission interface 13.

Please refer to FIG. 2 and FIG. 3. Specifically, the cholesteric liquid crystal writing tablet 10 receives a writing pressure and displays a writing trace according to a motion path of the writing pressure. Notably, the display principle of the cholesteric liquid crystal writing tablet 10 is different from that of the liquid crystal display having a thin-film transistor (TFT) array. In the process of painting or writing, the cholesteric liquid crystal writing tablet 10 displays the writing image due to the writing pressure applied to the cholesteric liquid crystal writing tablet 10. In other words, the cholesteric liquid crystal writing tablet 10 can display the writing image without power supply.

In the instant embodiment of the instant disclosure, the cholesteric liquid crystal writing tablet 10 includes a bottom substrate 101, a flexible plate 102, a first conductive layer 103, a second conductive layer 104, and a cholesteric liquid crystal layer 105.

The bottom substrate 101 can be a transparent or non-transparent plastic substrate, such as PET substrate. The bottom substrate 101 has an upper surface (not labeled) and a lower surface (not labeled) opposite to the upper surface. When the bottom substrate 101 is transparent, the cholesteric liquid crystal writing tablet 10 may further include a color layer 106 formed on the lower surface of the bottom substrate 101. In one embodiment, the color layer 106 is in a dark color or in black, and can be formed on the bottom substrate 101 by spray. In another embodiment, when the bottom substrate 101 is non-transparent, such as black, the color layer 106 can be omitted.

The first conductive layer 103 is disposed on the upper surface of the bottom substrate 101. In other words, in the embodiment shown in FIG. 2, the first conductive layer 103 and the color layer 106 are respectively located at two opposite sides of the bottom substrate 101. The first conductive layer 103 can be a transparent conductive layer. For example, the first conductive layer 103 can be made of indium tin oxide (ITO) or conductive polymer. In another embodiment, the first conductive layer 103 can be made of a conductive material in a dark color, such as graphene. When the first conductive layer 106 is made of a conductive material in a dark color, the color layer 106 can be omitted.

The flexible plate 102 can be a transparent plastic plate having flexibility, which can deform due to an external pressure. The flexible plate 102 can be made of PET or other polymer materials. The flexible plate 102 and the bottom substrate 101 are disposed facing and spaced from each other. The flexible plate 102 has a writing/display surface 100 for receiving the writing pressure.

The second conductive layer 104 is disposed on the flexible plate 102 and faces the first conductive layer 103. Specifically, the second conductive layer 104 is located at a side of the flexible plate 102 opposite to the writing/display surface 100. The second conductive layer 104 and the first conductive layer 103 can be made of the same material, such as transparent conductive material.

As shown in FIG. 2, the cholesteric liquid crystal layer 105 is interposed between the flexible plate 102 and the bottom substrate 101. Specifically, the cholesteric liquid crystal layer 105 is interposed between the first conductive layer 103 and the second conductive layer 104. Furthermore, the state of the liquid crystal (LC) molecules of the cholesteric liquid crystal layer 105 can be changed due to the applied pressure or the electric field. The liquid crystal (LC) molecules can be resting in either of two stable states, i.e., either in focal conic state or in planar state, which is called “bistability.” The LC molecules can be set in focal conic state so that the writing/display surface 100 of the cholesteric liquid crystal writing tablet 10 displays dark background before the writing pressure is applied to the cholesteric liquid crystal writing tablet 10.

When the user is writing to apply the writing pressure to the writing/display surface 100 of the cholesteric liquid crystal writing tablet 10 by using an object, such as finger(s) or other articles, the state of some LC molecules, which receive the writing pressure, is changed from the transparent focal conic state to the reflecting planar state, thereby displaying white (or other colors) writing trace.

Please refer to FIG. 2. The trace recording unit 11 is disposed on a side of the cholesteric liquid crystal writing tablet 10 opposite to the writing/display surface 100. Specifically, as shown in FIG. 1, the trace recording unit 11 is electrically connected to the processing module 12. The trace recording unit 11 detects the position coordinate where the writing pressure is applied, and transmits the position coordinate to the processing module 12.

In one embodiment, the trace recording unit 11 is a touch panel having a touch sensing circuit layout formed thereon, in which the touch panel senses the variation of the resistance, the capacitance or illumination to determine the position coordinate where the writing pressure is applied by the user. Specifically, the touch panel can be a resistive touch panel, a capacitive touch panel, an optical touch panel, and so forth, and the type of the touch panel is not limited in the instant disclosure. In another embodiment, the trace recording unit 11 can be electronic-magnetic sense board/components that can detect the RF signal to decide the position coordinate so that the writing trace can be detected and recorded.

Please refer to FIG. 2. In one embodiment, the electronic writing apparatus 1 further includes a trace input unit P1 for cooperating together with the trace recording unit 11. When the trace input unit P1 is used by the user to write on the writing/display surface 100 of the cholesteric liquid crystal writing tablet 10, the trace recording unit 11 can detect the position coordinate of the position where the trace input unit P1 is located.

For example, the trace input unit P1 is an electromagnetic pen, and the trace recording unit 11 is an electromagnetic board. The electromagnetic pen is served as a signal transmitter, and the electromagnetic board is served as a signal receiver. When the user presses the flexible plate 102 of the cholesteric liquid crystal writing tablet 10 with the electromagnetic pen and the pressed position accordingly has an indent, the electromagnetic board can detect the variation of the magnetic flux passing through the pressed position where the electromagnetic pen applies the writing pressure, thereby determining the position coordinate of the pressed position.

Please refer to FIG. 1. The processing module 12 receives the position coordinate transmitted by the trace recording unit 11 and converts the position coordinate into writing data corresponding to the writing trace. The writing data includes at least one of the trace data file, the graphic file, and video file.

Please refer to FIG. 3. For example, when the user writes the first writing trace S1 and the second writing trace S2 on the writing/display surface 100 in a time order by using the trace input unit P1, the processing module 12 can receive and convert the position coordinate to the writing data corresponding to the first writing trace S1 and the second writing trace S2. The position coordinate is generated by the trace recording unit 11 upon receiving the input of the trace input unit P1. In one embodiment, the writing data includes the graphic file for illustrating a final image, i.e., showing the first writing trace S1 and the second writing trace S2 simultaneously.

In another embodiment, the processing module 12 converts the received position coordinate to the writing data, which can be a video file or a flash file for sequentially showing the writing traces according to a time sequence.

Take the embodiment shown in FIG. 3 as an example to describe in detail. The user sequentially writes the first writing trace S1 and the second writing trace S2 on the writing/display surface 100. Meanwhile, the processing module 12 determines the sequence of the first writing trace S1 and the second writing trace S2 according to the receiving time of the position coordinate, and produces the writing data. That is to say, the writing data is trace data, which includes the recording sequence of the first writing trace S1 and the second writing trace S2.

Please return to FIG. 1. The transmission interface 13 is electrically connected to the processing module 12 so that the writing data can be transmitted to and stored in a cloud computing system 3 or an external electronic apparatus 4 through the transmission interface 13. The external electronic apparatus 4 can be a personal computer, a smartphone, a tablet, a personal digital assistant (PDA), a projector, or a printer.

In the embodiment of the instant disclosure, the transmission interface 13 includes a communication module 130 and a connecting port 131. The communication module 130 can be a wire communication module or a wireless communication module, such as a Bluetooth transmission module, a WiFi transmission module, and the like. In one embodiment, the writing data is transmitted to and stored in the cloud computing system 3 through the wireless communication module and the internet 2. Furthermore, the writing data stored in the cloud computing system 3 can be downloaded and read by using other electronic devices, such as a smartphone, a table, or a laptop.

The connecting port 131 can be a USB connection port. In another embodiment, the processing module 12 can transmit the writing data to the external electronic apparatus 4 which can be a personal computer, a smartphone, a tablet, a PDA, a projector or a printer, through the connecting port 131.

Additionally, in the instant disclosure, the electronic writing apparatus 1 of the embodiment can further include a storage unit 16 for storing the writing data. The storage unit 16 is electrically connected to the processing module 12. That is to say, all of the writing data generated at different times can be transmitted to and temporarily stored in the storage unit 16. Thereafter, all of the writing data stored in the storage unit 16 can be transmitted to the external electronic apparatus 4 through the transmission interface 13. The storage unit 16 can include at least one of a hard disk, a flash memory, and a card-type storage medium. Accordingly, the electronic writing apparatus 1 in the embodiment of the instant disclosure can store the writing data generated when the user finishes writing or drawing.

Furthermore, as shown in FIG. 1 and FIG. 2, the electronic writing apparatus 1 includes a voltage supply unit 14 electrically connected to the cholesteric liquid crystal writing tablet 10 and an operation interface 15 electrically connected to the voltage supply unit 14.

Specifically, the voltage supply unit 14 is electrically connected to the first conductive layer 103 and to the second conductive layer 104. After the user finishes writing or drawing and the writing data is stored, the user can input a recovery command through the operation interface 15.

The voltage supply unit 14 receives the recovery command through the operation interface 15 and provides a recovery voltage to the first conductive layer 103 and the second conductive layer 104 according to the recovery command so as to generate an electric field in the cholesteric liquid crystal layer 105, so that the liquid crystal molecules return to an initial state. That is to say, in the applied electric field, some liquid crystal molecules, which have been driven from the focal conic state to the planar state due to the writing pressure, return to the focal conic state. Accordingly, the writing traces, such as the first writing trace S1 and the second writing trace S2, shown in the writing/display surface 100 can be completely removed.

In addition, the operation interface 15 can be electrically connected to the processing module 12. After the user finishes writing or drawing, the user can input a storage instruction through the operation interface 15. After receiving the storage instruction, the processing module 12 transmits the writing data to the storage unit 16 or to the external electronic apparatus 4 through the transmission interface 13. As shown in FIG. 3, the operation interface 15 can be a plurality of functional buttons or a touch panel area disposed on the outer surface of the electronic writing apparatus 1.

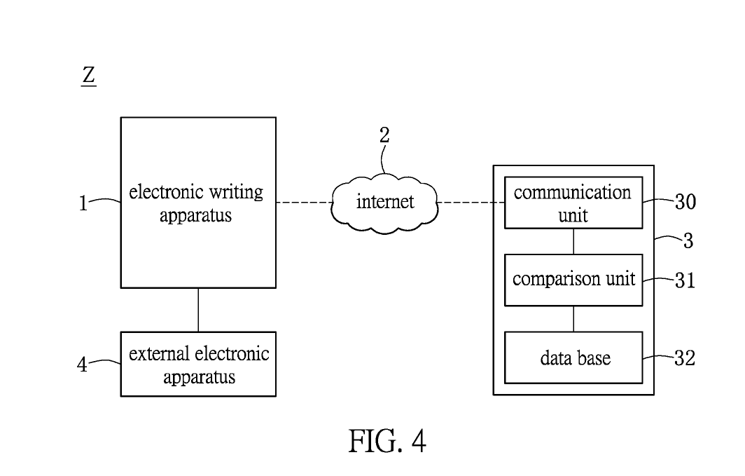

In another embodiment of the instant disclosure, the electronic writing apparatus 1 can be applied to an authentication system Z. Please refer to FIG. 4 showing a functional diagram of a signature authentication system including an electronic writing apparatus according to an embodiment of the instant disclosure. More specifically, the authentication system Z includes the electronic writing apparatus 1 and the cloud computing system 3. The authentication system Z can be applied in an identification system, a financial system, a credit card system, and so on.

The electronic writing apparatus 1 can be electrically connected to another external electronic apparatus 4 or be integrated in electronic equipment (such as a card reader). The user identification can be verified through the electronic writing apparatus 1 to be authorized to use the external electronic apparatus 4.

As shown in FIG. 4, the cloud computing system 3 includes a communication unit 30, a comparison unit 31, and a data base 32 electrically connected to the comparison unit 31.

The cloud computing system 3 receives and sends instruction or information to the electronic writing apparatus 1. The data base 32 stores at least one of verification data. In one embodiment, the verification data includes at least one of user-identification data and an initial writing data corresponding to the user-identification data.

In one embodiment, the data base 32 can be established by generating a writing data corresponding to the user-identification data. The writing data can be an authentication code, which is inputted by the user through the electronic writing apparatus 1. The authentication code can include name, number, sentence, graphic or a combination thereof. The electronic writing apparatus 1 produces and transmits the initial writing data, which corresponds to the authentication code and the user-identification data, to the data base 32 of the cloud computing system 3. The initial writing data can include at least one of the trace data file, the graphic file, and the video file. The graphic file records the final image, and the video file and the trace data file record the writing traces according to a time sequence. In one preferred embodiment, the initial writing data not only includes the graphic file for recording the final image, but also the trace data file.

When the authentication is performed, the user inputs the authentication code through the electronic writing apparatus 1. The electronic writing apparatus 1 generates authentication writing data and transmits the authentication writing data to the comparison unit 31 of the cloud computing system 3.

The comparison unit 31 retrieves the initial writing data, which corresponds to the authentication code and the user-identification data, from the data base 32 and compares the initial writing data and the authentication writing data to verify the user identity. Specifically, the comparison unit 31 can compare the graphic file of the initial writing data with that of the authentication writing data, or compare the trace data file of the initial writing data with that of the authentication writing data to determine whether the authentication writing data is consistent with the initial writing data, thereby verifying the user identity.

After the authentication process, the comparison unit 31 produces an identity verification data to the electronic writing apparatus 1. The processing unit 12 (shown in FIG. 1) receives the identify verification data through the transmission interface 13 and transmits a command to the external electronic apparatus 4 to authorize the user to use the external electronic apparatus 4.

The electronic writing apparatus 1 of the embodiments in the instant disclosure includes the trace recording unit 11 for detecting the position coordinate where the writing pressure is applied and the transmission interface 13 so that the writing data can be transmitted to and stored in the cloud computing system 3 or the external electronic apparatus 4. Furthermore, the electronic writing apparatus 1 can be implemented in an identification system, a financial system, a credit card system, and so on. The security and the accuracy of the identity verification can be improved by utilizing the electronic writing apparatus 1.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. An electronic writing apparatus comprising:
a cholesteric liquid crystal writing tablet having a writing/display surface for receiving a writing pressure to display a writing trace according to a motion path of the writing pressure;
a trace recording unit disposed on a side of the cholesteric liquid crystal writing tablet opposite to the writing/display surface for detecting a position coordinate of the writing pressure;
a processing module electrically connected to the trace recording unit, wherein the processing module receives and converts the position coordinate of the writing pressure to a writing data corresponding to the writing trace; and
a transmission interface electrically connected to the processing module, wherein the processing module transmits the writing data to a cloud computing system or an external electronic apparatus through the transmission interface for storage.

2. The electronic writing apparatus according to claim 1, wherein the cholesteric liquid crystal writing tablet comprises:
a bottom substrate;
a flexible plate disposed facing and spaced from the bottom substrate, wherein the flexible plate includes the writing/display surface for receiving the writing pressure;
a first conductive layer disposed on the bottom substrate;
a second conductive layer disposed on the flexible plate and facing the first conductive layer; and
a cholesteric liquid crystal layer interposed between the first conductive layer and the second conductive layer, wherein the state of some liquid crystal molecules of the cholesteric liquid crystal layer is changed due to the writing pressure.

3. The electronic writing apparatus according to claim 2, wherein the cholesteric liquid crystal writing tablet further comprises a color layer disposed on the bottom substrate, and the color layer and the first conductive layer are respectively located at two opposite sides of the bottom substrate.

4. The electronic writing apparatus according to claim 2, further comprising a voltage supply unit electrically connected to the first conductive layer and the second conductive layer, wherein the voltage supply unit provides a recovery voltage to the first conductive layer and the second conductive layer according to a recovery command so that some liquid crystal molecules whose state have been changed due to the writing pressure return to an initial state.

5. The electronic writing apparatus according to claim 4, further comprising an operation interface electrically connected to the voltage supply unit, and the voltage supply unit receiving the recovery command through the operation interface.

6. The electronic writing apparatus according to claim 1, further comprising a trace input unit for cooperating together with the trace recording unit, wherein the trace input unit is an electromagnetic pen, the trace recording unit is an electromagnetic board, and the cholesteric liquid crystal writing tablet is disposed on the electromagnetic board.

7. The electronic writing apparatus according to claim 1, wherein the writing data includes at least one of a trace data file, a graphic file, and a video file.

8. The electronic writing apparatus according to claim 1, wherein the processing module converts the position coordinate of the writing pressure to the writing data, which includes a trace data file or a video file for sequentially showing the writing trace according to a time sequence.

9. The electronic writing apparatus according to claim 1, further comprising a storage unit electrically connected to the processing module and for storing the writing data.

10. The electronic writing apparatus according to claim 1, wherein the cloud computing system includes a comparison unit and a data base electrically connected to the comparison unit for storing at least a verification data, the comparison unit receives the writing data from the processing module, compares the verification data and the writing data to generate an identity verification data, and transmits the identity verification data to the processing module through the transmission interface.

11. The electronic writing apparatus according to claim 1, wherein the transmission interface includes at least one of a communication module and the connecting port, and the communication module is a wireless communication module or a wire communication module.
